(19) United States
(12) Patent Application Publication
(10) Pub. No.: US 2026/0295660 A1
(43) Pub. Date: Oct. 1, 2026

(54) TRIMMING DEVICE AND TRIMMING METHOD

(71) Applicant: HONDA MOTOR CO., LTD., Tokyo (JP)

(72) Inventors: Hiroyuki NAOI, Tokyo (JP); Keiichi TAKAGI, Tokyo (JP); Hiroshi MATSUI, Tokyo (JP); Toru TANAKA, Tokyo (JP); Takayasu DAIMON, Tokyo (JP)

(21) Appl. No.: 19/556,049

(22) Filed: Mar. 4, 2026

(30) Foreign Application Priority Data
Mar. 27, 2025 (JP) 2025-053015

(51) Int. Cl. B22D 31/00; B26D 1/08; B26D 7/01

(52) U.S. Cl. CPC B22D 31/00; B26D 1/08; B26D 7/01

(57) ABSTRACT

A trimming device according to one embodiment of the present invention includes: a lower die having a placement table on which a product portion of a molded product is placed, and a lower blade movable in an upward-downward direction relative to the placement table; an upper die that is arranged above the molded product and has an upper blade corresponding to the lower blade, and a press part extending in a downward direction; and a controller that controls upward and downward movement of the upper die, at least one of the upper die and the lower die being controlled by the controller such that, after the unnecessary portion of the molded product is cut off by the upper blade and the lower blade, the press part presses the product portion downward.

This application is based on and claims the benefit of priority from Japanese Patent Application No. 2025-053015, filed on 27 Mar. 2025, the content of which is incorporated herein by reference.

### BACKGROUND OF THE INVENTION

### Field of the invention

The present invention relates to a trimming device and a trimming method.

### Related Art

Conventionally, there has been proposed a product distortion correction device configured by adding a distortion correction mechanism to a trimming press die having a trimming blade that removes an unnecessary portion of a casting product (see Patent Document 1). The product distortion correction device of Patent Document 1 can correct distortion in an area of the casting product that requires surface precision in a first stage of pressing with the trimming press die, and can cut off the unnecessary portion with the trimming blade in a second stage of pressing.

Patent Document 1: Japanese Unexamined Patent Application, Publication No. H8-164468

### SUMMARY OF THE INVENTION

However, with the product distortion correction device of Patent Document 1, after correcting the distortion of the casting product by the distortion correction mechanism, an unnecessary portion around a peripheral edge of a flange portion is cut off by a trim die attached to the trimming press die, and, therefore, it is difficult to correct distortion that occurs during cutting, and it is difficult to correct the distortion of the product with high precision.

The purpose of the present invention is to provide a trimming device and a trimming method that can, in a single press stroke, cut off an unnecessary portion of a molded product having a product portion and the unnecessary portion and correct the distortion of the product portion with high precision by one press stroke.

(1) A trimming device for cutting off an unnecessary portion of a molded product having a product portion and the unnecessary portion, the trimming device including: a lower die having a placement table on which the product portion of the molded product is placed, and a lower blade that is movable in an upward-downward direction relative to the placement table; an upper die that is arranged above the molded product and has an upper blade corresponding to the lower blade, and a press part extending in a downward direction; and a controller that controls upward and downward movement of the upper die, at least one of the upper die and the lower die being controlled by the controller such that, after the unnecessary portion of the molded product is cut off by the upper blade and the lower blade, the press part presses the product portion downward.

According to the trimming device defined in (1), the upper blade and the press part are arranged in the upper die, and, after the unnecessary portion of the molded product is cut off by the upper blade and the lower blade, the press part presses the product portion downward, thereby correcting the distortion of the product portion. Therefore, it is possible to both cut off the unnecessary portion of the molded product and correct the distortion of the product portion with high precision in an efficient manner by one press stroke of the upper die.

(2 )The trimming device defined in 1, including a lower-blade lift that moves the lower blade downward following further downward movement of the upper die after cutting off the unnecessary portion.

According to the trimming device defined in (2), since the lower blade moves downward following the further downward movement of the upper die, the downward movement of the upper die is not hindered, and the upper die can be smoothly moved downward. Therefore, it is possible to more reliably both cut off the unnecessary portion of the molded product and correct the distortion of the product portion by one press stroke of the upper die.

(3) The trimming device defined in (1) or (2), wherein the lower blade is supported by a plate, and the plate is configured to be movable in an upward-downward direction by a cylinder.

According to the trimming device defined in (3), since the lower blade is movable in the upward-downward direction by the cylinder via the plate, it is possible to more reliably both cut off the unnecessary portion of the molded product and correct the distortion of the product portion by one press stroke of the upper die.

(4) The trimming device defined in (3), wherein the upper die further has a push pin extending in a downward direction, and the plate is provided with a push-pin seat that is pressed by the push pin.

According to the trimming device defined in (4), upward and downward movements of the upper die and the lower blade are controlled by the push pin and the push-pin seat, thereby stabilizing the upward and downward movements of the upper die and the lower blade. Therefore, it is possible to more reliably both cut off the unnecessary portion of the molded product and correct the distortion of the product portion by one press stroke of the upper die.

(5) The trimming device defined in (3), wherein the upper die further has a push pin that corresponds to the lower blade, extends downward at a position in the upper die corresponding to an upper portion of the product portion, and is arranged to press the lower blade via the product portion.

According to the trimming device defined in (5), upward and downward movements of the upper die and the lower blade are controlled by the push pin and the lower blade, thereby stabilizing the upward and downward movements of the upper die and the lower blade. Therefore, it is possible to more reliably both cut off the unnecessary portion of the molded product and correct the distortion of the product portion by one press stroke of the upper die.

(6) The trimming device defined in any one of (1) to (3), wherein a lower end of the upper blade is located lower than a lower end of the press part.

According to the trimming device defined in (6), since the product portion of the molded product comes into contact with the press part after the upper blade cuts off the unnecessary portion of the molded product, it is possible to more reliably both cut off the unnecessary portion of the molded product and correct the distortion of the product portion by one press stroke of the upper die.

(7) The trimming device defined in any one of (1) to (6), wherein the upper die further has an upper-blade support part that supports the upper blade and is movable in an upward-downward direction, and a pushing part that is arranged to be movable independently of the upper-blade support part and is able to move in the upward-downward direction, and, after the pushing part holds the product portion in place, the upper blade and the lower blade cut off the unnecessary portion.

According to the trimming device defined in (7), the upper-blade support part and the pushing part can be moved in the upward-downward direction separately from each other. Consequently, by one press stroke of the upper die, it is possible to first hold the product portion securely in place by the pushing part and then move the upper blade to cut off the unnecessary portion, and, thus, it is possible to both cut off the unnecessary portion of the casting product and correct the distortion of the product portion with higher precision.

(8) The trimming device defined in any one of (1) to (7), wherein the lower die further has a positioning part protruding from a placement surface of the placement table, the positioning part having an upper portion on which the product portion is to be secured, and the positioning part has, on a face that comes into contact with a lower end of the product portion, a tapered face that narrows upward, and the product portion is secured in a state in which the product portion is in contact with the tapered face, and a clearance is formed between a back surface of the product portion and a top face of the positioning part.

According to the trimming device defined in (8), since the product portion of the molded product is secured in contact with the tapered face of the positioning part, the position of the molded product placed on the placement table is stable. Therefore, the unnecessary portion of the molded product can be cut off stably at a predetermined position, and the distortion of the product portion of the molded product can be corrected stably at a predetermined position. Thus, it is possible to more reliably both cut off the unnecessary portion of the casting product and correct the distortion of the product portion by one press stroke of the upper die.

(9) The trimming device defined in (8), wherein at least two positioning parts are provided in an extending direction of the lower blade, and the tapered face is tapered in a direction orthogonal to the extending direction.

According to the trimming device defined in (9), since at least two positioning parts are provided in the extending direction of the lower blade, the position of the molded product placed on the placement table is more stable. Therefore, it is possible to more reliably both cut off the unnecessary portion of the casting product and correct the distortion of the product portion by one press stroke of the upper die.

(10) A trimming method for cutting off an unnecessary portion of a molded product having a product portion and the unnecessary portion, using a trimming device including an upper die and a lower die, the lower die having a placement table on which the product portion of the molded product is placed and a lower blade movable in an upward-downward direction relative to the placement table, the upper die being configured to be movable in an upward-downward direction relative to the placement table and having an upper blade and a press part extending in a downward direction, the trimming method including: a step of installing the trimming device; a step of placing the product portion of the molded product on the placement table; a step of moving the lower blade upward and moving the upper die downward to cut off the unnecessary portion of the molded product by shear forces generated by the upper blade and the lower blade; and a step of moving the upper die further downward and pressing the product portion downward by the press part.

According to the trimming method defined in (10), since the unnecessary portion of the molded product is cut off by the upper blade and the lower blade and, after cutting off the unnecessary portion, the product portion is pressed downward by the press part, it is possible to correct the distortion that occurred in the product portion during casting and trimming of the product portion. Therefore, it is possible to more reliably both cut off the unnecessary portion of the casting product and correct the distortion of the product portion by one press stroke of the upper die.

According to the present invention, it is possible to provide the trimming device and the trimming method that can, by one press stroke of the upper die, both cut off an unnecessary portion of a molded product having a product portion and the unnecessary portion, and correct the distortion of the product portion.

### BRIEF DESCRIPTION OF THE DRAWINGS

FIG. 1 is a perspective view showing a configuration of a trimming device according to a first embodiment;

FIG. 2A is a schematic view showing a state in which a molded product is placed on a placement table of the trimming device according to the first embodiment;

FIG. 2B is a schematic view showing a state in which an upper die has been moved downward in the trimming device according to the first embodiment;

FIG. 2C is a schematic view showing a state after cutting off an unnecessary portion by an upper blade and a lower blade in the trimming device according to the first embodiment;

FIG. 2D is a schematic view showing a state in which a product portion is pressed by a press part in the trimming device according to the first embodiment;

FIG. 3 is a conceptual diagram showing a change in load over time within the device caused by a trimming method using the trimming device according to the first embodiment;

FIG. 4A is a schematic view showing a state in which the molded product is placed on the placement table of a trimming device according to a second embodiment;

FIG. 4B is a schematic view showing a state in which the unnecessary portion is removed by the upper blade and the lower blade of the trimming device according to the second embodiment;

FIG. 4C is a schematic view showing a state in which the product portion is pressed by the press part of the trimming device according to the second embodiment;

FIG. 5A is a schematic view showing a state in which the molded product is placed on the placement table of a trimming device according to a third embodiment;

FIG. 5B is a schematic view showing a state in which a product pushing part affixes the product in the trimming device according to the third embodiment;

FIG. 5C is a schematic view showing a state in which the unnecessary portion is removed by the upper blade and the lower blade of the trimming device according to the third embodiment; and

FIG. 5D is a schematic view showing a state in which the product portion is pressed by the press part of the trimming device according to the third embodiment.

### DETAILED DESCRIPTION OF THE INVENTION

### First Embodiment

Hereinafter, the first embodiment of the present invention will be described in detail with reference to the drawings. Note that the drawings show schematic configurations of a trimming device according to the present invention, but do not show the detailed shape of the actual device. Moreover, four predetermined directions orthogonal to each other are indicated as the "Fr direction", "Rr direction", "R direction", and "L direction". The "Fr direction" represents a front direction when the trimming device is viewed from the front, the "Rr direction" represents a rear direction when the trimming device is viewed from the front, the "R direction" represents a right direction when the trimming device is viewed from the front, and the "L direction" represents a left direction when the trimming device is viewed from the front.

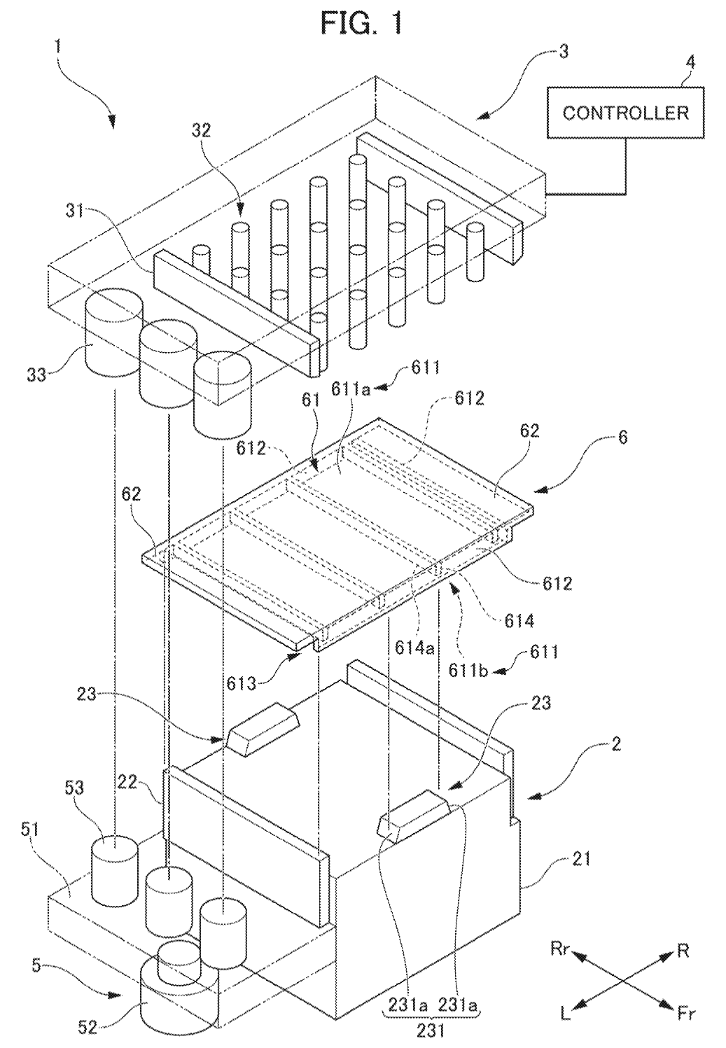

FIG. 1 is an exploded perspective view showing a configuration of a trimming device 1 according to the present embodiment. A molded product 6 is, for example, a molded product formed by a casting method and solidified in the shape of a cavity of a mold provided in a casting device. Therefore, the molded product 6 has a product portion 61, which is an object of manufacturing, and unnecessary portions 62, 62 formed in a gating system that is a channel through which molten metal flows. The unnecessary portions 62, 62 are portions that need to be cut off by the trimming device 1 in a product manufacturing step. Note that, in FIG. 1, a movable part of an upper die 3 and a plate 51 of a lower-blade lift 5 are indicated by long dashed double-dotted lines.

The product portion 61 has a top face 611, side faces 612, 612, 612 surrounding three sides, a side opening 613 opening in the L direction, and a plurality of ribs 614. The top face 611 has a front surface 611a and a back surface 611b. The top face 611 is a portion where distortion caused by compressive stress during casting, or distortion caused by residual stress occurring due to temperature variation during a cooling step after casting, is likely to remain.

Each rib 614 is formed to protrude downward from the back surface 611b, and has a lower end 614a. The lower end 614a of the rib 614 is located higher than a lower end of each side face 612. The unnecessary portions 62, 62 are formed to protrude from both ends of the product portion 61 in the L direction and the R direction. Consequently, the unnecessary portions 62, 62 are placed in the trimming device 1 while being supported by the side faces 612, 612, 612, and a space is formed under the rib 614 protruding from the back surface 611b of the product portion 61. Note that the shape of the product portion 61 is not limited to this. For example, the product portion 61 may not have any rib 614.

As shown in FIG. 1, the trimming device 1 includes: a lower die 2 on which the molded product 6 is placed; the upper die 3 that is arranged above the molded product 6 placed on the lower die 2; a controller 4 that controls upward and downward movement of the upper die 3 ; and the lower-blade lift 5. The lower die 2 has a placement table 21 and a lower blade 22. The placement table 21 is a table for placing thereon the product portion 61 of the molded product 6, and has a placement surface 211 and a pair of positioning parts 23, 23.

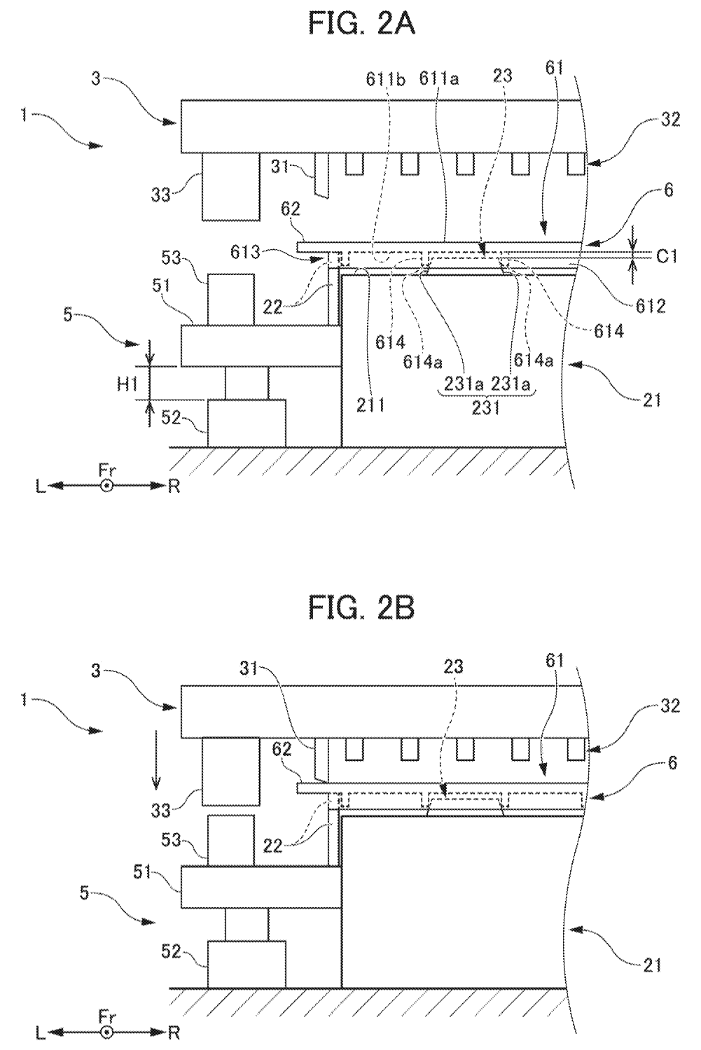

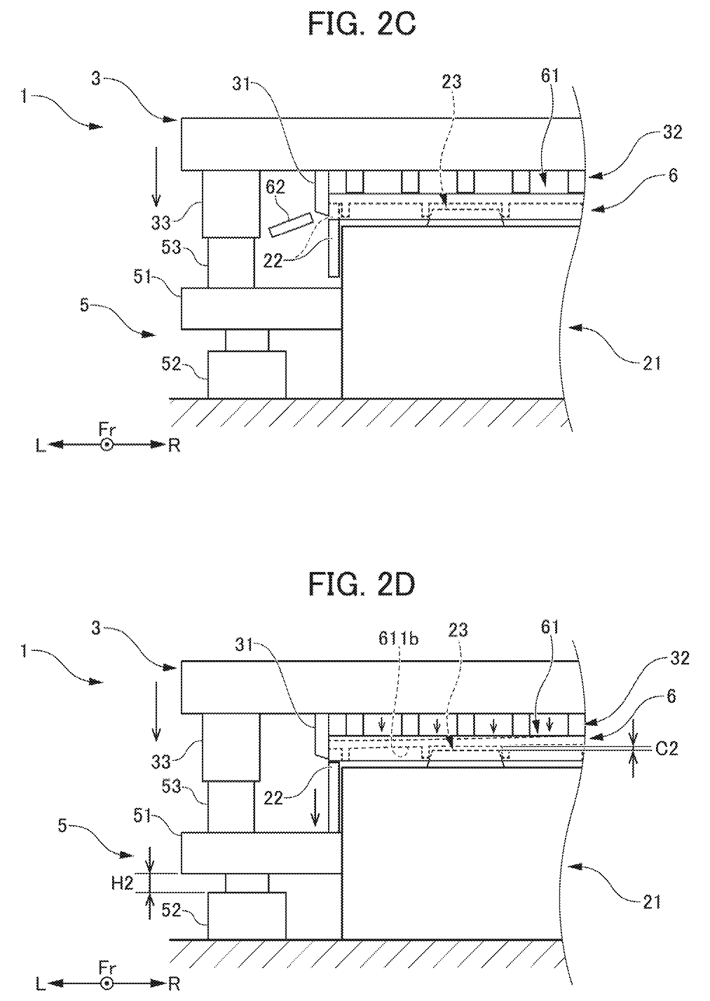

Each positioning part 23 is arranged to protrude from the placement surface 211, and the product portion 61 is placed on an upper portion of the positioning part 23. At least two positioning parts 23 are provided in an extending direction (Fr-Rr direction) of the lower blade 22, and a taper 231 is formed in a direction orthogonal to the extending direction. The taper 231 includes a pair of tapered faces 231a, 231a. The tapered faces 231a, 231a are formed to make an upwardly narrowing shape. As shown in FIG. 2A, the positioning part 23 is arranged such that, when the product portion 61 is placed on the placement surface 211, the lower ends 614a, 614a of the pair of ribs 614, 614 come into contact with the tapered faces 231a, 231a.

The ribs 614, 614 of the product portion 61 are secured in contact with the tapered faces 231a, 231a of the positioning part 23. When the product portion 61 is placed on the placement surface, the pair of ribs 614, 614 come into slidably contact with the tapered faces 231a, 231a of the positioning part 23, thereby allowing positioning of the product portion 61 in the extending direction of the lower blade 22.

Since two positioning parts 23 of the present embodiment are arranged at an end in the Fr direction and an end in the Rr direction of the placement surface 211 to be spaced apart from each other, it is possible to make positioning of the product portion 61 at two locations in the extending direction of the lower blade 22. Therefore, it is possible to correctly position the product portion 61 relative to the lower blade 22, and it is possible to cut off the unnecessary portion 62 from the product portion 61 with high precision. At least two positioning parts 23 need to be provided, and a plurality of the positioning parts 23 may be arranged on the placement surface 211 according to the shape of the molded product.

As shown in FIG. 1, the lower blade 22 is arranged to be movable in an upward-downward direction relative to the placement table 21 by the lower-blade lift 5, which will be described later. The upper die 3 has an upper blade 31 corresponding to the lower blade 22, a press part 32 extending downward, and a push pin 33 extending downward. The upper blade 31 and the lower blade 22 are a pair of corresponding block-shaped blades, and the shape of each blade, such as thickness, can be set depending on the shape of the molded product 6.

The upper blade 31 and the lower blade 22 can cut off the unnecessary portion 62 by shear forces that are generated when the upper blade 31 moves downward and the lower blade 22 moves upward.

After cutting off the unnecessary portion 62, the press part 32 moves downward following downward movement of the upper die 3, and a tip of the press part 32 presses the top face 611 of the product portion 61 placed on the placement table 21. As described above, since the space is formed under the rib 614 provided to the product portion 61, a central portion of the top face 611 in the vicinity of the unnecessary portion 62 can be bent downward by the press part 32 as shown in FIG. 2D. The pressing by the press part 32 corrects the distortion of the product portion 61. Therefore, even if a new distortion occurs in the product portion 61 when cutting off the unnecessary portion 62, the distortion of the product portion 61 can be efficiently corrected, and the distortion is less likely to remain in the product portion 61.

The press part 32 is constituted by a plurality of pins. The diameter, number, and intervals of the pins constituting the press part 32, and the length extending downward from the upper die can be freely designed depending on conditions, for example, the shape of the product portion 61 and the magnitude of distortion.

The push pin 33 is arranged at a position facing a push-pin seat 53 of the lower-blade lift 5, which will be described later.

The lower-blade lift 5 includes the plate 51 and a cylinder 52. The push-pin seat 53 is provided on a top face of the plate 51. The lower blade 22 is supported by the plate 51. There are no particular restrictions for the cylinder 52, and, for example, a gas spring, a hydraulic cylinder, or a gas cylinder can be used. A plurality of cylinders 52 may be provided.

When the push pin 33 moves downward following the upper die 3, the push-pin seat 53 is pressed by the push pin 33. When the push-pin seat 53 is pressed, the cylinder 52 is activated, and the plate 51 descends. The lower blade 22 also descends as the plate 51 descends.

Note that, in FIG. 1, although three push pins 33 and three push-pin seats 53, each of which is cylindrical in shape, are arranged, there are no particular restrictions on the shapes and number of the push pins 33 and the push-pin seats 53, and the shapes and number of the push pins 33 and the push-pin seats 53 can be set depending on conditions, for example, the shape of the product portion 61.

The controller 4 is provided to control the upward and downward movement of the upper die 3. By controlling the amount of movement of the upper die 3 by the controller 4, an amount of pressure to be applied by the press part 32 to the product portion 61 after cutting off the unnecessary portion 62 by the upper blade 31 can be adjusted, and the distortion of the product portion 61 can be appropriately corrected.

Next, a trimming method for the molded product 6, using the trimming device 1, will be described. FIG. 2A is a view showing a state in which the upper die 3 starts to descend. First, the product portion 61 of the molded product 6 is placed on the positioning part 23 provided on the placement surface 211 of the placement table 21. At this time, positioning of the product portion 61 is reliably performed by bringing the ribs 614, 614 of the product portion 61 into contact with the tapered faces 231a, 231a of the positioning part 23. The product portion 61 is secured to the placement table 21 such that a clearance C1 is formed between the back surface 611b of the product portion 61 and the top face of the positioning part 23.

When the upper die 3 starts to descend, the push pin 33 of the upper die 3 and the push-pin seat 53 of the lower-blade lift 5 are physically apart from each other, and, therefore, a load applied to the plate 51 is zero, and a stretchable part of the cylinder 52 maintains a height H1 (maximum value).

FIG. 2B is a view showing a state in which trimming of the unnecessary portion 62 is started. When the upper die 3 is moved downward, the upper blade 31 comes into contact with the front surface 611a of the product portion 61. At this time, since the push pin 33 has not yet come into contact with the push-pin seat 53, the plate 51 does not receive any load, and the height of the stretchable part of the cylinder 52 does not change. Moreover, like the push pin 33, since the press part 32 also has not yet come into contact with the front surface 611a of the product portion 61, the product portion 61 does not receive any load.

FIG. 2C is a view showing a state after the trimming of the unnecessary portion 62 has been finished. The upper die 3 is moved further downward, and the unnecessary portion 62 of the molded product 6 is cut off by the lower blade 22 and the upper blade 31 that has moved downward following the upper die 3. At this time, a load for performing trimming is applied to the upper die 3. By further descending the upper die 3, the stretchable part of the cylinder 52 starts to contract, and, as shown in FIG. 2C, the press part 32 can come into contact slightly with the front surface 611a of the product portion 61.

FIG. 2D is a view showing a state in which the press part 32 is pressing the product portion 61. When the upper die 3 is moved further downward, the press part 32 presses the front surface 611a of the product portion 61 downward. At this time, a load for pressing is applied to the upper die 3. When the product portion 61 is pressed downward, the top face 611 is deformed, and the clearance C1 between the back surface 611b of the top face 611 and the top face of the positioning part 23 becomes narrower and changes to a clearance C2. Since the clearance C1 is provided in advance when placing the product portion 61, the product portion 61 can easily deform downward.

As the product portion 61 deforms downward, the residual stress in the product portion 61 is released, and the distortion of the product portion 61 is corrected. Moreover, since the residual stress in the unnecessary portion 62 is large, the distortion in the vicinity of the unnecessary portion 62 may affect the distortion of the product portion 61. Therefore, after cutting off the unnecessary portion 62 from the product portion 61, it is desirable to correct the product portion 61. The cylinder 52 is set such that, when the upper die 3 is moved downward, the stretchable part of the cylinder 52 has a minimum value (H2) until the distortion of the product portion 61 is corrected.

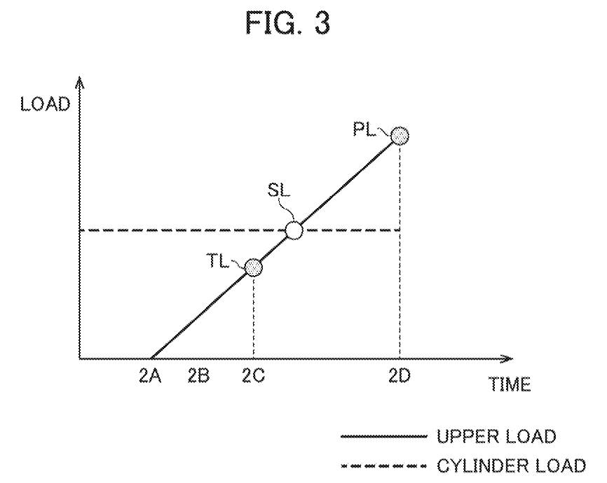

FIG. 3 is a conceptual diagram showing a change in load over time within the device caused by the trimming method using the trimming device 1, which is described above. A cylinder load to be applied to the cylinder 52 is set to a constant value and does not change from the time when the trimming device 1 is installed. An upper die load applied to the upper die 3 continues to increase from when the upper die starts to descend (2A) until the trimming start time (2B) when the upper blade 31 comes into contact with the product portion 61. Next, the unnecessary portion 62 is trimmed by the upper blade 31 and the lower blade 22. An upper die load TL during trimming of the unnecessary portion 62 is smaller than the cylinder load. Therefore, the cylinder 52 remains unchanged during trimming, and the position of the plate 51 that comes into contact with the cylinder 52 does not change.

At the end of trimming (2C), as the upper die 3 continues to descend, the upper die load increases, and the press part 32 comes into contact with the front surface 611a of the product portion 61. Here, the upper die load reaches the cylinder load and becomes an upper die load SL equal to the cylinder load. When the upper die 3 descends further, the upper die load increases beyond the upper die load SL. Consequently, the cylinder 52 starts to descend, and the press part 32 can start pressing the product portion 61. An upper die load PL during the pressing (2D) is greater than the upper die load TL and the upper die load SL.

The trimming device 1 is configured such that the maximum values of the loads satisfy a relationship: the upper die load TL during trimming < the upper die load SL having the same value as the cylinder load < the upper die load PL during pressing. By satisfying this configuration requirement, both the trimming of the unnecessary portion 62 and the correction of the distortion of the product portion 61 can be performed in one stroke of moving the upper die 3 downward by the trimming method using the trimming device 1.

According to the trimming device 1 of the present embodiment, the upper blade 31 and the press part 32 are arranged in the upper die 3, and, after the unnecessary portion 62 of the molded product 6 is cut off by the upper blade 31 and the lower blade 22, the press part 32 presses the product portion 61 of the molded product 6 downward to correct the distortion of the product portion 61. Therefore, it is possible to efficiently both cut off the unnecessary portion 62 of the molded product 6 and correct the distortion of the product portion 61 by one press stroke of the upper die 3.

The molded product 6 is constituted by the product portion 61 and the unnecessary portion 62, and, in the cooling step after casting, temperature variation is likely to occur in the unnecessary portion 62, and residual stress tends to remain. Therefore, the largest distortion is likely to occur in the unnecessary portion 62 and the periphery of the product portion 61 in the vicinity of the unnecessary portion 62. According to the trimming device 1 of the present embodiment, the distortion of the product portion 61 can be reduced by first cutting off the unnecessary portion 62 in which residual stress tends to remain and releasing some residual stress remaining in the product portion 61. Furthermore, by moving the upper die 3 downward, the lower blade 22 is retracted from below the product portion 61 to ensure a space allowing pressing of the product portion 61 and to enable correction of the distortion of the product portion 61.

### Second Embodiment

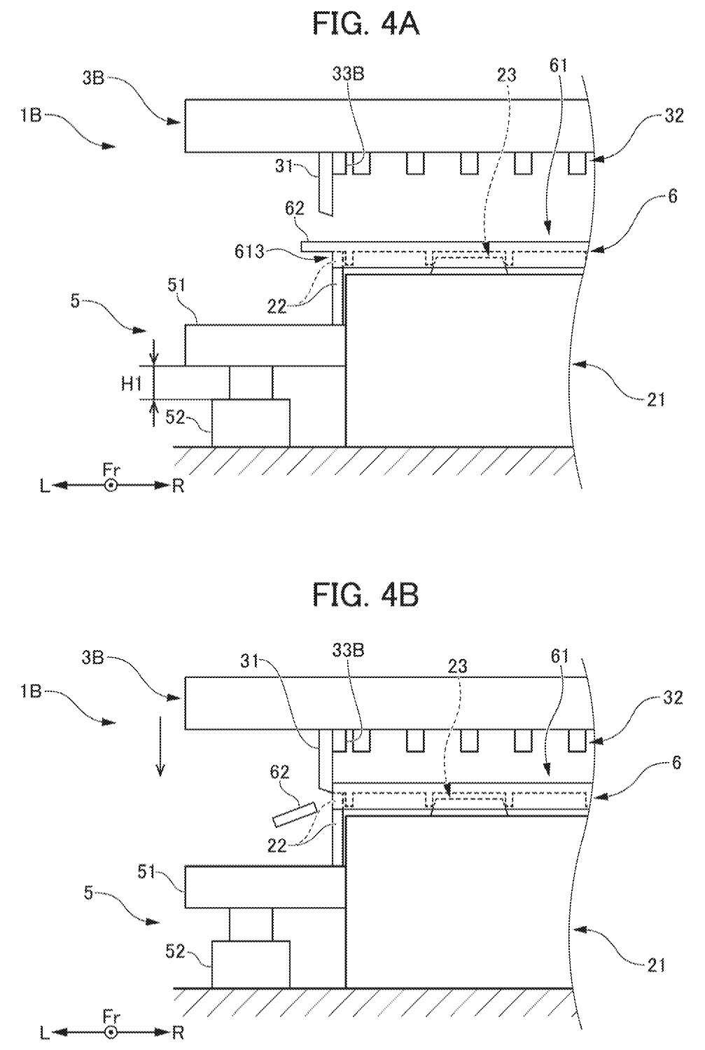

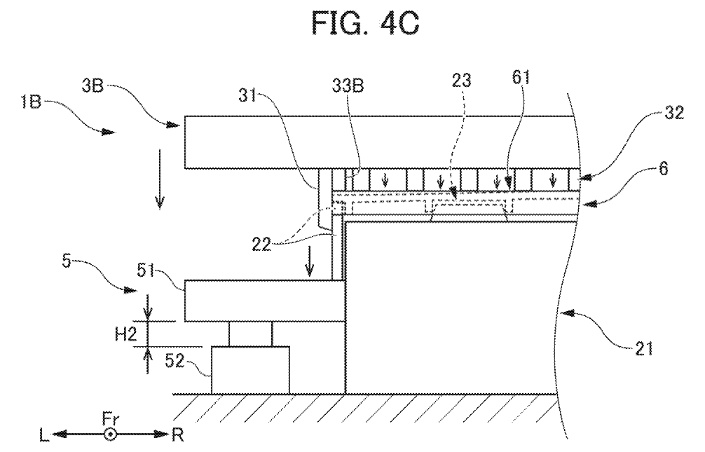

Next, the second embodiment of the present invention will be described in detail with reference to FIGS. 4A to 4C. As shown in FIG. 4A, a trimming device 1B of the second embodiment is different from the trimming device 1 of the first embodiment in that a push pin 33B is arranged at a position in an upper die 3B to face the lower blade 22, and the push pin 33 and the push-pin seat 53 are not included. Since other components are the same as in the first embodiment, the same reference numerals are given, and detailed descriptions are omitted.

The push pin 33B is provided between the upper blade 31 and the press part 32, and the lower end of the push pin 33B is configured to be located higher than the lower end of the upper blade 31.

Next, a trimming method using the trimming device 1B will be described. When the upper die3B is moved downward, the push pin 33B and the press part 32 also move downward together with the upper blade 31. Then, as shown in FIG. 4B, the unnecessary portion 62 is cut off by the upper blade 31 and the lower blade 22.

When the upper die 3B is moved further downward, as shown in FIG. 4C, the push pin 33B presses the lower blade 22 via the product portion 61 when the product portion 61 is pressed by the press part 32. When the lower blade 22 is pressed, the cylinder load is applied to the cylinder 52 via the lower blade 22 and the plate 51. Referring to FIG. 3, The cylinder load increases from the time (2C) when the push pin 33 comes into contact with the push-pin seat 53. The cylinder load increases, similarly to the trimming device 1 of the first embodiment, to a load (B) when the stretchable part of the cylinder 52 has a minimum value (H2) and the distortion of the product portion 61 is corrected (2D).

According to the trimming device 1B of the present embodiment, like the trimming device 1 of the first embodiment, the upper blade 31 and the press part 32 are arranged in the upper die 3B, and, after the unnecessary portion 62 of the molded product 6 is cut off by the upper blade 31 and the lower blade 22, the press part 32 presses the product portion 61 of the molded product 6 downward to correct the distortion of the product portion 61. Therefore, it is possible to efficiently both cut off the unnecessary portion 62 of the molded product 6 and correct the distortion of the product portion 61 by one press stroke of the upper die 3B.

According to the trimming device 1B of the present embodiment, since the lower-blade lift 5 for moving the lower blade 22 downward can be configured in a simpler form, it is possible to more easily manufacture the trimming device 1B. Moreover, since no push-pin seat is required, it is possible to provide a trimming device that can be installed in a smaller space.

Note that the push pin 33B of the present embodiment is provided at the position facing the lower blade 22, but the push pin of the present invention is not limited to this. As long as the push pin can push down the lower blade 22 via the product portion 61, the push pin may be provided at any position in the upper die 3B.

### Third Embodiment

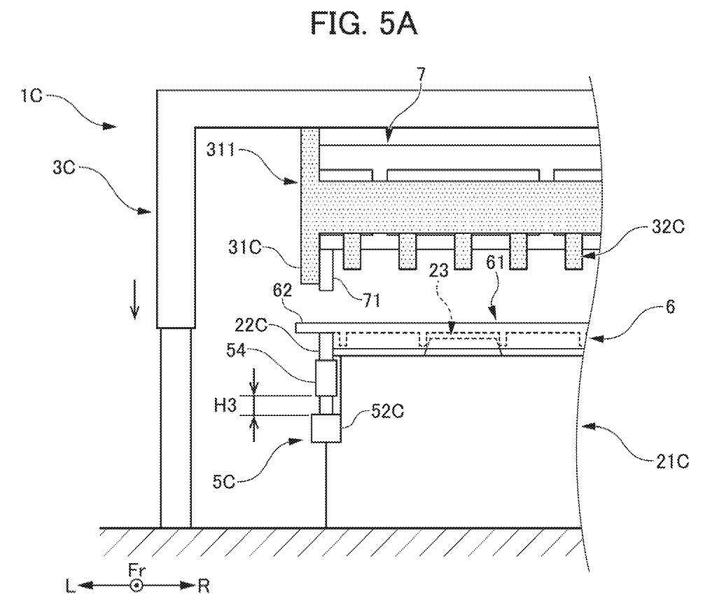

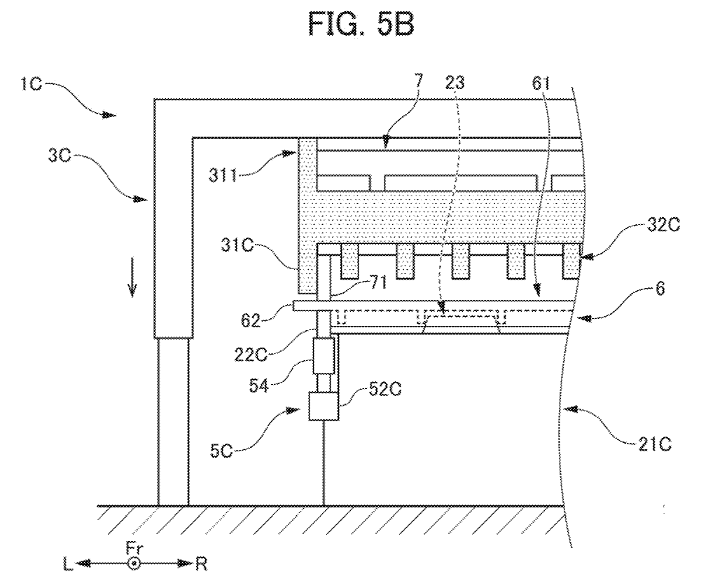

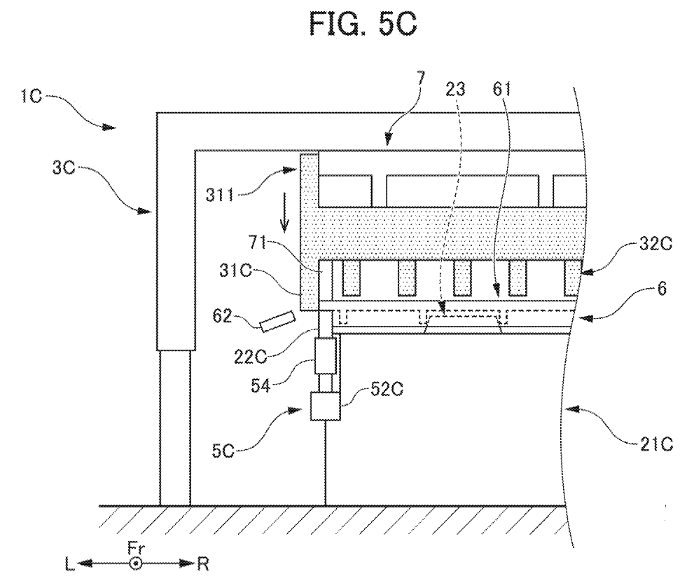

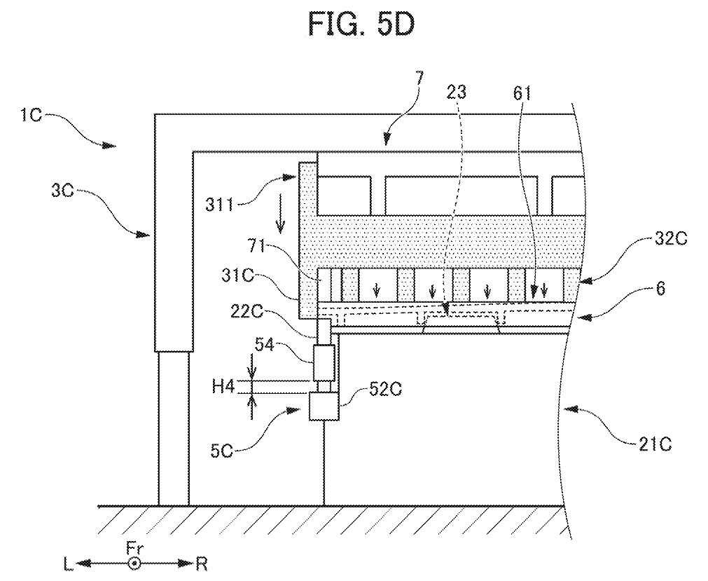

The third embodiment of the present invention will be described in detail with reference to FIGS. 5A to 5D. As shown in FIG. 5A, a trimming device 1C of the third embodiment is different from the trimming device 1 of the first embodiment in that an upper die 3C has an upper-blade support part 311 and a pushing part 7, and does not have any push pin 33 for pressing down a lower blade 22C. Since other components are the same as in the first embodiment, the same reference numerals are given, and detailed descriptions are omitted.

As shown in FIG. 5A, the upper die 3C of the trimming device 1C has the upper-blade support part 311 that supports an upper blade 31C and a press part 32C so as to be movable in an upward-downward direction, and the pushing part 7 that securely holds the product portion 61 of the molded product 6 in place. The upper-blade support part 311 and the pushing part 7 are configured to be movable in the upward-downward direction simultaneously with the upper die 3C, following the movement of the upper die 3C, and also to be able to move in the upward-downward direction separately from each other.

The upper blade 31C and the lower blade 22C are arranged facing each other so as to come into contact with each other. The length of the press part 32C is uniform, and the lower end of the upper blade 31C is located lower than the lower end of the press part 32C. The pushing part 7 has a pushing piece 71 that comes into contact with the product portion 61 to hold the product portion 61 in place. Note that, in FIGS. 5A to 5D, the upper-blade support part 311 is indicated by dot hatching.

A lower-blade lift 5C has a cylinder 52C and a support block 54. The lower blade 22C is supported by the support block 54 to be movable in the upward-downward direction, and is placed under the unnecessary portion 62. The cylinder 52C is embedded in a placement table 21C. Since the configuration of the cylinder 52C is the same as the cylinder 52 in the first embodiment, explanation thereof is omitted. The stretchable part of the cylinder 52C maintains a height H3 in a state in which no load is applied.

A trimming method using the trimming device 1C will be described. As shown in FIG. 5B, when the upper die 3C moves downward, the upper-blade support part 311 and the pushing part 7 also move downward simultaneously. Since the lower end of the pushing piece 71 is located lower than the lower ends of the upper blade 31C and the press part 32C, the pushing part 7 can first securely hold the product portion 61 of the molded product 6 in place. Consequently, the product portion 61 is held immovably between the lower blade 22C and the pushing piece 71.

Next, as shown in FIG. 5C, in a state in which the pushing part 7 holds the product portion 61 in place, the upper-blade support part 311 further descends independently, and the unnecessary portion 62 of the molded product 6 can be cut off by shear forces generated by the upper blade 31C and the lower blade 22C.

Next, as shown in FIG. 5D, after cutting off the unnecessary portion 62, when the upper die 3C further descends, the support block 54 supporting the lower blade 22C also moves downward, the cylinder 52C contracts maximally, and maintains the stretchable part of the cylinder 52C at a height H4 lower than the height H3. At this time, the press part 32C follows the movement of the upper-blade support part 311 and presses the product portion 61, thereby correcting the distortion.

According to the trimming device 1C of the present embodiment, since the trimming device 1 of the first embodiment is further provided with the pushing part 7, it is possible to cut off the unnecessary portion 62 while securely holding the product portion 61 in place, and correct the distortion. Consequently, it is possible to both cut off the unnecessary portion 62 of the molded product 6 and correct the distortion of the product portion 61 with higher precision by one press stroke of the upper die 3C.

The preferred embodiments of the present invention have been described above, but the present invention is not limited to these embodiments. The present invention is not limited to the above embodiments, and various modifications are possible within the scope of the gist of the present invention. For example, in the embodiments, although the upper die 3, 3C is moved downward, the upper die 3, 3C may be moved downward relative to the lower die 2, 2C by moving the lower die 2, 2C upward relative to the upper die 3, 3C. Furthermore, the upper die may be provided with a push pin.

### EXPLANATION OF REFERENCE NUMERALS

C1 clearance; 1, 1B, 1C trimming device; 2 lower die, 3, 3C upper die; 4 controller; 5, 5C lower-blade lift; 6 molded product; 7 pushing part; 21, 21C placement table; 22, 22C lower blade; 23 positioning part; 31, 31C upper blade; 32, 32C press part; 33, 33B push pin; 51 plate; 52, 52C cylinder; 53 push-pin seat; 61 product portion; 62 unnecessary portion; 211 placement surface; 231 taper; 231a, 231a tapered face; 311 upper-blade support part; 611b back surface; and 614a lower end (lower end of product portion).

What is claimed is:

1. A trimming device for cutting off an unnecessary portion of a molded product having a product portion and the unnecessary portion, the trimming device comprising:
a lower die having a placement table on which the product portion of the molded product is placed, and a lower blade that is movable in an upward-downward direction relative to the placement table;
an upper die that is arranged above the molded product and has an upper blade corresponding to the lower blade, and a press part extending in a downward direction; and
a controller that controls upward and downward movement of at least one of the upper die and the lower die,
at least one of the upper die and the lower die being controlled by the controller such that, after the unnecessary portion of the molded product is cut off by the upper blade and the lower blade, the press part presses the product portion downward.

2. The trimming device according to claim 1, comprising a lower-blade lift that moves the lower blade downward following downward movement of the upper die after cutting off the unnecessary portion.

3. The trimming device according to claim 1, wherein the lower blade is supported by a plate, and the plate is configured to be movable in an upward-downward direction by a cylinder.

4. The trimming device according to claim 3, wherein the upper die further has a push pin extending in a downward direction, and the plate is provided with a push-pin seat that is pressed by the push pin.

5. The trimming device according to claim 3, wherein the upper die further has a push pin that corresponds to the lower blade, extends downward at a position in the upper die corresponding to an upper portion of the product portion, and is arranged to press the lower blade via the product portion.

6. The trimming device according to claim 1, wherein a lower end of the upper blade is located lower than a lower end of the press part.

7. The trimming device according to claim 1, wherein the upper die further has an upper-blade support part that supports the upper blade and is movable in an upward-downward direction, and
a pushing part that is arranged to be movable independently of the upper blade and is able to move in the upward-downward direction, and,
after the pushing part holds the product portion in place, the upper blade and the lower blade cut off the unnecessary portion of the molded product.

8. The trimming device according to claim 1, wherein the lower die further has a positioning part protruding from a placement surface of the placement table, the positioning part having an upper portion on which the product portion is to be secured,
the positioning part has, on a face that comes into contact with a lower end of the product portion, a tapered face that narrows upward, and
the product portion is secured in a state in which the product portion is in contact with the tapered face, and a clearance is formed between a back surface of the product portion and a top face of the positioning part.

9. The trimming device according to claim 8, wherein at least two positioning parts are provided in an extending direction of the lower blade, and
the tapered face is tapered in a direction orthogonal to the extending direction.

10. A trimming method for cutting off an unnecessary portion of a molded product having a product portion and the unnecessary portion, using a trimming device including an upper die and a lower die,
the lower die having a placement table on which the product portion of the molded product is placed and a lower blade movable in an upward-downward direction relative to the placement table,
the upper die being configured to be movable in an upward-downward direction relative to the placement table and having an upper blade and a press part extending in a downward direction,
the trimming method comprising: a step of installing the trimming device;
a step of placing the product portion of the molded product on the placement table;
a step of moving the lower blade upward and moving the upper die downward to cut off the unnecessary portion of the molded product by shear forces generated by the upper blade and the lower blade; and
a step of moving the upper die further downward and pressing the product portion downward by the press part.
